(19) United States
(12) Patent Application Publication
(10) Pub. No.: US 2025/0353107 A1
(43) Pub. Date: Nov. 20, 2025

(54) LASER DRILLING SYSTEM

(71) Applicant: K2 LASER SYSTEM INC., Anyang-si (KR)

(72) Inventors: Myeong Soo KIM, Anyang-si (KR); Yeoungcheol KIM, Anyang-si (KR); Jae Hyok KIM, Anyang-si (KR); Jooho JUNG, Anyang-si (KR); Ko Dong PARK, Anyang-si (KR)

(21) Appl. No.: 19/193,480

(22) Filed: Apr. 29, 2025

(30) Foreign Application Priority Data
May 17, 2024 (KR) 10-2024-0064601
Jun. 20, 2024 (KR) 10-2024-0080362

(51) Int. Cl. B23K 26/06; B23K 26/067

(52) U.S. Cl. CPC B23K 26/0648; B23K 26/067

(57) ABSTRACT

The present invention relates to a laser drilling system that perforates a porous pattern using multiple laser beams, and an object thereof is to provide a laser drilling system that enhances productivity by forming multiple spots using a diffractive optical system to simultaneously process several point arrays. To that end, the present invention may disclose a laser drilling system comprising a laser source outputting a single laser beam, a diffractive optical system converting the single laser beam into multiple laser beams and outputting the multiple laser beams, a helical optical system spacing the multiple laser beams apart from a central axis, laterally offsetting the multiple laser beams, and outputting the multiple laser beams, a scanner changing a position and propagation path of the multiple laser beams laterally offset from the central axis and outputting the multiple laser beams, and a focus lens radiating the multiple laser beams output from the scanner onto a focal plane of a workpiece to drill a porous pattern.

### CROSS-REFERENCE TO RELATED APPLICATION(S)

This application claims priority to Korean Patent Application Nos. 10-2024-0064601, filed on 2024 May 17, and 10-2024-0080362 filed on 2024 Jun. 20, in the Korean Intellectual Property Office, the disclosures of which are incorporated by reference herein in their entireties.

### TECHNICAL FIELD

The present invention relates to a laser drilling system for drilling a porous pattern using multiple laser beams.

### DISCUSSION OF RELATED ART

Solid oxide fuel cells (SOFC) are known to operate in a relatively wide temperature range compared to other fuel cells, and are used as small home power generation devices as well as large-scale distributed power generation. As illustrated in FIG. 1, for example, an SOFC 10 includes a support 1 partially made to have a porous pattern or a through hole 2, a cathode layer 3 covering the porous pattern 2 of the support 1, an electrolyte layer 4 stacked on the cathode layer 3, an anode layer 5 provided on the electrolyte layer 4, and a thick anode current collecting layer 6 provided on the anode layer 5 to collect current.

In general, the above-described support includes a metal substrate, which may include an anode support type, an electrolyte support type, or a metal support type. The metal support may not only lower the manufacturing costs of battery cells but also possesses excellent strength and flexibility without causing shrinkage during subsequent heat treatment processes. As described above, the central portion of the metal support should have a porous structure that facilitates the supply and transmission of fuel gas, and the edge portion that is not in direct contact with the cell should have a dense structure to form a gas flow path and prevent gas leakage.

To this end, the central metal support with a porous structure (porous region) and the edge portion metal support with a dense structure may be coupled to each other by welding or the like. However, it is not easy to couple them, and the coupled portions may have structural weakness. Recently, a method for generating a porous pattern only in the central portion of the integrated support with a laser has been studied.

The description disclosed in the Background section is only for a better understanding of the background of the invention and may also include information which does not constitute the prior art.

### SUMMARY

An object of the present invention is to provide a laser drilling system for drilling a porous pattern using multiple laser beams capable of forming multiple spots using a diffractive optical system and simultaneously processing several point arrays to enhance productivity.

Further, another object of the present invention is to provide a laser drilling system with enhanced performance by processing a through hole with decreased tapering due to beam waist by performing helical drilling using wedge prisms.

A laser drilling system according to the present invention may comprise a laser source outputting a single laser beam, a diffractive optical system converting the single laser beam into multiple laser beams and outputting the multiple laser beams, a helical optical system spacing the multiple laser beams apart from a central axis, laterally offsetting the multiple laser beams, and outputting the multiple laser beams, a scanner changing a position and propagation path of the multiple laser beams laterally offset from the central axis and outputting the multiple laser beams, and a focus lens radiating the multiple laser beams output from the scanner onto a focal plane of a workpiece to drill a porous pattern.

In one or more embodiments, the diffractive optical system may include a beam expander uniformly expanding the single laser beam, a diffractive optical element splitting the expanded single laser beam into the multiple laser beams, and a lens transforming the split multiple laser beams into parallel beams.

In one or more embodiments, the diffractive optical system may further include a beam blocking mask blocking the multiple laser beams of a high order.

In one or more embodiments, the helical optical system may include a first wedge prism having an incident surface and an exit surface at different angles to space the multiple laser beams apart from the central axis, and a second wedge prism having an incident surface and an exit surface at different angles and, as a horizontal distance from the first wedge prism is adjusted, laterally offsetting and outputting the multiple laser beams.

In one or more embodiments, the helical optical system may further include a polarizer disposed between the first wedge prism and the second wedge prism to reduce a transverse and longitudinal offset caused by polarization.

In one or more embodiments, the helical optical system may adjust diameters of an inlet and an outlet of the porous pattern of the workpiece, and an inclined surface between the inlet and the outlet by changing a relative horizontal distance between the first wedge prism and the second wedge prism without changing angles of the first wedge prism and the second wedge prism.

In one or more embodiments, the helical optical system may set a maximum variable horizontal distance between the first wedge prism and the second wedge prism in a state where a focal point is aligned at a center of an aperture of the scanner.

In one or more embodiments, the scanner may include a two-axis Galvano mirror scanner. The two-axis Galvano mirror scanner may cause each of the multiple laser beams to perform helical motion to drill the porous pattern into the workpiece, and translate in parallel all of the multiple laser beams incident on the workpiece.

In one or more embodiments, the focus lens may include an F-theta lens. Each of the multiple laser beams having the same angle of incidence may be focused on the same location of the workpiece by the F-theta lens.

In one or more embodiments, the diffractive optical system may be rotated to adjust a pitch of the multiple laser beams.

The present invention may provide a laser drilling system for drilling a porous pattern using multiple laser beams capable of forming multiple spots using a diffractive optical system and simultaneously processing several point arrays to enhance productivity.

Further, the present invention may provide a laser drilling system with enhanced performance by processing a through hole with decreased tapering due to beam waist by performing helical drilling using wedge prisms.

### BRIEF DESCRIPTION OF THE DRAWINGS

FIG. 1 is a view schematically illustrating an exemplary solid oxide fuel cell (SOFC).

FIG. 2 is a view schematically illustrating a configuration of a laser drilling system according to the present invention.

FIG. 3 is a view schematically illustrating a configuration and operation of a diffractive optical system in a laser drilling system according to the present invention.

FIGS. 4A, 4B, and 4C are views schematically illustrating a configuration and operation of a helical optical system in a laser drilling system according to the present invention.

FIGS. 5A and 5B are views schematically illustrating a configuration and operation of a scanner in a laser drilling system according to the present invention.

FIGS. 6A and 6B are views schematically illustrating a configuration and operation of a focus lens in a laser drilling system according to the present invention.

FIGS. 7A and 7B are views schematically illustrating a simultaneous operation of laser beams by a porous pattern drilling system using exemplary multiple laser beams according to the present invention.

FIG. 8 is a view schematically illustrating a pattern movement operation by a laser drilling system according to the present invention.

FIG. 9 is a view schematically illustrating a pattern change operation by a laser drilling system according to the present invention.

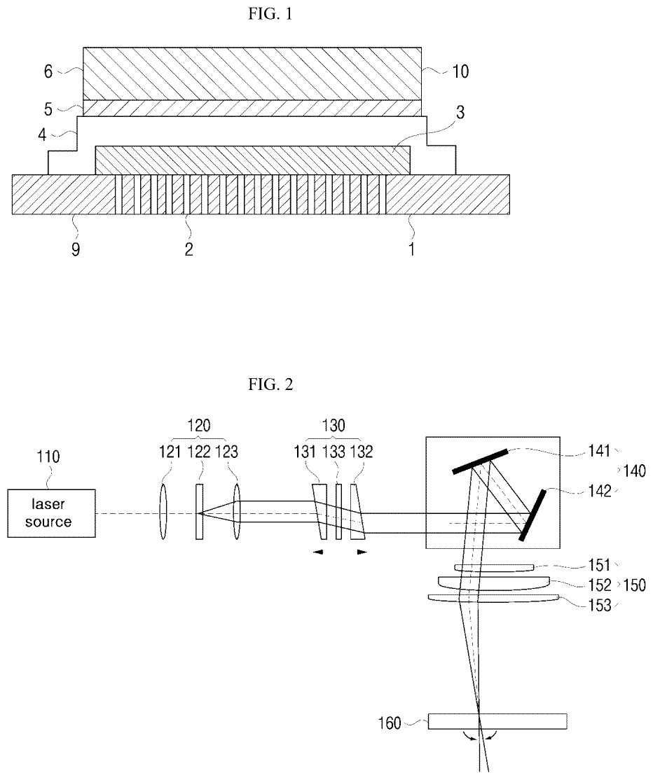

### DETAILED DESCRIPTION

Hereinafter, preferred embodiments of the present invention are described in detail with reference to the accompanying drawings.

The present invention is provided to more completely describe the present invention to those skilled in the art, and the following embodiments may be modified in various different forms, and the scope of the present invention is not limited to the following embodiments. Embodiments of the disclosure are provided to fully and thoroughly convey the spirit of the present invention to those skilled in the art.

As used herein, the thickness and size of each layer may be exaggerated for ease or clarity of description. The same reference denotations may be used to refer to the same or substantially the same elements throughout the specification and the drawings. As used herein, the term “A and/or B” encompasses any, or one or more combinations, of A and B. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

The terms as used herein are provided merely to describe some embodiments thereof, but not intended as limiting the present invention. As used herein, the singular forms “a,” “an,” and “the” are intended to include the plural forms as well, unless the context clearly indicates otherwise. As used herein, the term “comprise,” “include,” and/or “comprising” or “including” does not exclude the presence or addition of one or more other components, steps, operations, and/or elements than the component, step, operation, and/or element already mentioned.

As used herein, the terms “first” and “second” may be used to describe various members, parts, regions, areas, layers, and/or portions, but the members, parts, regions, areas, layers, and/or portions are not limited thereby. These terms are used merely to distinguish one member, part, region, area, layer, or portion from another. Accordingly, the term “first member,” “first part,” “first region,” “first area,” “first layer,” or “first portion” described herein may denote a “second member,” “second part,” “second region,” “second area,” “second layer,” or “second portion” without departing from the teachings disclosed herein.

The terms “beneath,” “below,” “lower,” “under,” “above,” “upper,” “on,” or other terms to indicate a position or location may be used for a better understanding of the relation between an element or feature and another as shown in the drawings. However, embodiments of the present invention are not limited thereby or thereto. For example, where a lower element or an element positioned under another element is overturned, then the element may be termed as an upper element or element positioned above the other element. Thus, the term “under” or “beneath” may encompass, in meaning, the term “above” or “over.”

As described herein, the controller and/or other related devices or parts may be implemented in hardware, firmware, application specific integrated circuits (ASICs), software, or a combination thereof. For example, the controller and/or other related devices or parts or its or their components may be implemented in a single integrated circuit (IC) chip or individually in multiple IC chips. Further, various components of the controller may be implemented on a flexible printed circuit board, in a tape carrier package, on a printed circuit board, or on the same substrate as the controller. Further, various components of the controller may be processes, threads, operations, instructions, or commands executed on one or more processors in one or more computing devices, which may execute computer programming instructions or commands to perform various functions described herein and interwork with other components. The computer programming instructions or commands may be stored in a memory to be executable on a computing device using a standard memory device, e.g., a random access memory (RAM). The computer programming instructions or commands may be stored in, e.g., a compact-disc read only memory (CD-ROM), flash drive, or other non-transitory computer readable media. It will be appreciated by one of ordinary skill in the art that various functions of the computing device may be combined together or into a single computing device or particular functions of a computing device may be distributed to one or other computing devices without departing from the scope of the present invention.

As an example, the controller of the present invention may be operated on a typical commercial computer including a central processing unit, a hard disk drive (HDD) or solid state drive (SSD) or other high-volume storage, a volatile memory device, a keyboard, mouse, or other input devices, and a monitor, printer, or other output devices.

Generally, when sintering a metal powder to generate a porous pattern, it may be difficult to uniform the distribution of pores, and microcracks may occur at the grain boundaries of the powder, which may lead to brittle fracture. Furthermore, it is challenging to measure the quality level, which presents difficulties in controlling the standardized specifications of the fuel cell.

On the other hand, laser processing may have a slower processing speed because it performs perforation by moving the position of a focused laser beam. To solve this problem, a method using a pulse train may be used. The laser pulse length, repetition rate, and scanner movement speed may be adjusted to consistently space the perforation points apart from each other, thereby enabling patterning. However, in order to reduce the decrease in speed caused by the acceleration and deceleration sections, the scanner may perform uninterrupted linear motion. Therefore, it is difficult to create perforation lines that are evenly spaced apart from each other by the laser pulse length and repetition rate.

For example, as the scan speed of the scanner increases with a fixed pulse repetition rate, the interval between holes of the hole pattern formed by the increasing interval between pulses may tend to increase. Conversely, if the pulse repetition rate is increased while the scanning speed of the scanner is fixed, the interval between holes may tend to decrease.

In this manner, in a perforation method using a pulse train, an acceleration section inevitably occurs before the scanner reaches a set speed level, and a deceleration section is generated at the end point of the line. In the acceleration and deceleration sections at both ends of the line, the perforation intervals are not uniform and may gradually widen or narrow. If it may be necessary to process a field composed of multiple lines, such areas may increase in size, which may lead to a decrease in the overall quality level.

Furthermore, since the laser has a Gaussian beam distribution, using a scanner may result in an inclined (tapering) cut surface, causing the diameters of the inlet and outlet, through which the laser energy penetrates, to differ. In severe cases, it is important to minimize the difference in diameter as it may hinder the smooth movement of ions.

FIG. 2 is a view schematically illustrating a configuration of a laser drilling system 100 according to the present invention.

As illustrated in FIG. 2, the laser drilling system 100 according to the present invention may include a laser source 110, a diffractive optical system 120, a helical optical system 130, a scanner 140, and a focus lens 150.

The laser source 110 may output a single laser beam. The laser source 110 may include a solid, gas, or liquid laser source. For example, a solid laser source generates a laser beam using a solid material. Representative solid lasers include Nd:YAG lasers and fiber lasers. The solid laser has strong output, excellent beam quality, and is suitable for processing a metal support used in the present invention. The gas laser source generates a laser beam using gas. Representative gas lasers may include CO2 lasers and helium-neon lasers. Gas lasers also have high output, low cost, and are suitable for non-metallic processing.

The diffractive optical system 120 may convert the single laser beam into multiple laser beams and output the same. As is described below in detail, the diffractive optical system 120 may include a beam expander 121, a diffractive optical element 122, and a lens 123.

The helical optical system 130 may space the multiple laser beams apart from the central axis and laterally offset the multiple laser beams, and output the same. As is described below in detail, the helical optical system 130 may include a first wedge prism 131, a second wedge prism 132, and a polarizer 133.

The scanner 140 may change the position and the propagation path of the multiple laser beams laterally offset from the central axis and output the multiple laser beams. As is described below in detail, the scanner 140 may include or be referred to as a two-axis Galvano mirror scanner, and for example, may include a first reflection mirror 141 and a second reflection mirror 142.

The focus lens 150 may perforate the porous pattern by radiating the multiple laser beams output from the scanner 140 to the focal plane of the workpiece 160. As is described below in detail, the focus lens 150 may include or be referred to as an F-theta lens, and for example, may include a first individual lens 151, a second individual lens 152, and a third individual lens 153.

As such, the laser drilling system 100 according to the present invention may enhance the overall processing speed using the multiple laser beams by the diffractive optical system 120 and reduce tapering due to drilling using the offset of the laser beam by the helical optical system 130. Particularly, when using the laser drilling system 100 according to the present invention, it may be possible to stably generate uniform pore sizes and distributions. Further, mass production may be facilitated by dramatically increasing the production speed compared to conventional laser drilling methods.

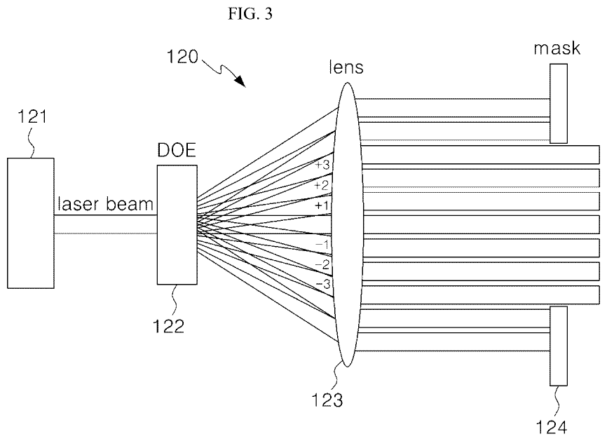

FIG. 3 is a view schematically illustrating a configuration and operation of the diffractive optical system 120 of the laser drilling system 100 according to the present invention.

As illustrated in FIG. 3, the diffractive optical system 120 may include a beam expander 121 that uniformly expands a single laser beam, a diffractive optical element 122 that splits the expanded single laser beam into multiple laser beams, and a lens 123 that transforms the multiple laser beams into parallel beams. In some examples, the diffractive optical system 120 may further include a beam blocking mask 124 that blocks the multiple laser beams of a high order.

As such, the diffractive optical system 120 may convert the single laser beam input through the laser source 110 into the multiple laser beams and output the multiple laser beams. For example, the diffractive optical system 120 may perform various optical functions such as splitting/merging, lens functions (condensing or diverging), light intensity distribution conversion functions, wavelength filter functions, and spectroscopic functions using the diffraction phenomenon of light. In the present invention, the diffractive optical system 120 may be used to form and split a laser beam in an energy-efficient manner. In some examples, to generate the multiple laser beams, the diffractive optical system 120 may generate a unique diffraction pattern by controlling the phase and amplitude of the incident beam, thereby generating multiple laser beams and adjusting the characteristics of each beam. This diffractive optical system 120 is particularly useful for high-precision and energy-efficient laser processing. In some examples, the diffractive optical system 120 may be manufactured by various methods such as hologram recording, ion beam etching, laser beam processing, or the like.

As such, the diffractive optical system 120 may generate multiple spot laser beams disposed in a matrix form from the incoming single laser beam. Further, simultaneous processing of a large area is possible without moving the galvo scanner or stage. The formed array may be composed of Gaussian, flat top (circular, rectangular, square), or line spots. When processing is performed using a single spot without the use of the diffractive optical system 120, the processing speed may be determined by the moving speed of the scanner 140 and the laser output. The spot distance may be changed by adjusting the pulse width and pulse frequency. In other words, the diffractive optical system 120 may form an N×N matrix in which N sub beams (where N is a natural number) are arranged.

In general, the Galvano mirror scanners have limitations in physical processing speed and number because they mechanically move one beam at high speed. Therefore, in the present invention, the diffractive optical system 120 may be used to split the laser beam incident from one point into a plurality of two-dimensional matrices with uniform intervals and sizes. The diffractive optical system 120 includes a diffractive optical element 122 (diffractive grating) and splits the laser beam into a plurality of sub laser beams using the diffraction phenomenon. If manufacturing of the diffractive optical system 120 is completed according to the process design, modification may not be possible, and the pattern of split beams that may be made by one diffractive optical system 120 may be fixed. The diffractive optical system 120 only splits the laser beam, and if the incident beam is a parallel light, the split beams are also parallel light, and if the incident beam is divergent light, the split beams are also divergent light having the same divergence. The optical characteristics of the diffractive optical system 120 (e.g., split characteristics such as intensity distribution on the image plane) may be described using either Fraunhofer diffraction or a Fourier transform function, even in the case of diffraction.

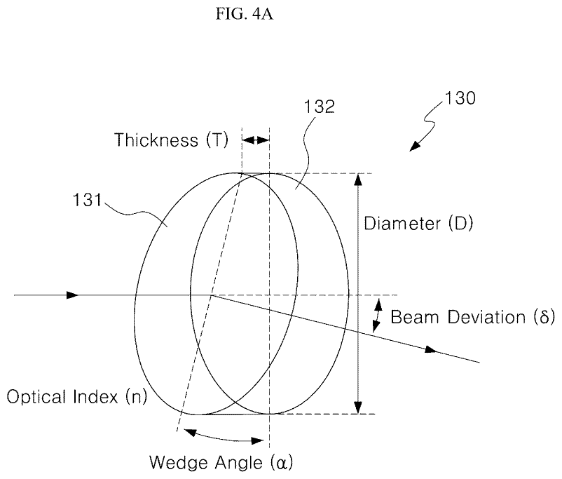

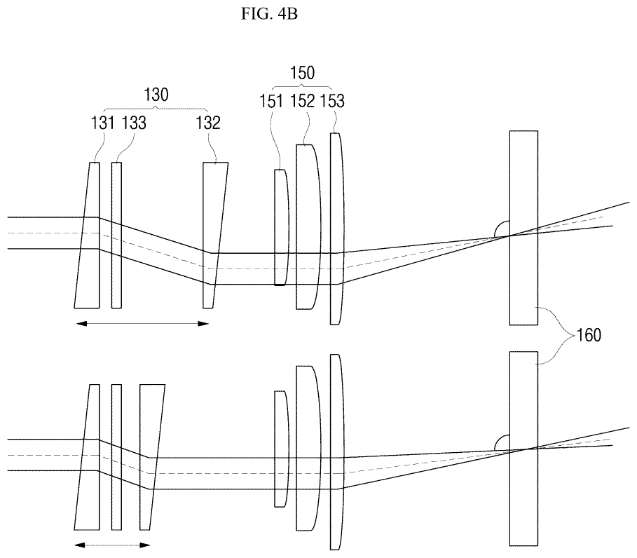

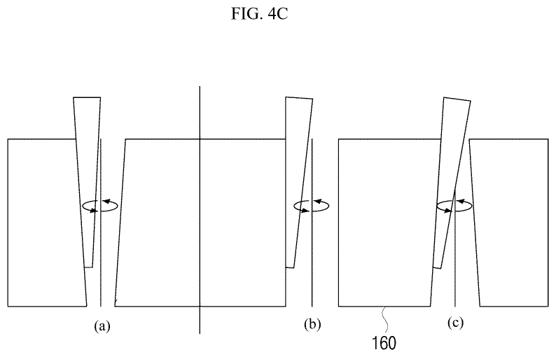

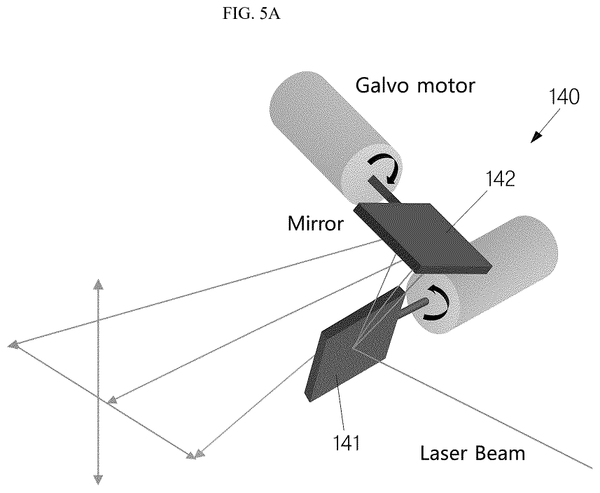

FIGS. 4A, 4B, and 4C are views schematically illustrating a configuration and operation of the helical optical system 130 of the laser drilling system 100 according to the present invention.

As illustrated in FIGS. 4A and 4B, the helical optical system 130 may include a first wedge prism 131 having the incident surface and the exit surface at different angles to space the multiple laser beams apart from the central axis, and a second wedge prism 132 allowing the horizontal distance from the first wedge prism 131 to be adjusted to laterally offset and output the multiple laser beams. In some examples, the helical optical system 130 may further include a polarizer 133 disposed between the first wedge prism 131 and the second wedge prism 132 to reduce the longitudinal/transverse offset due to polarization.

In some examples, the helical optical system 130 may set a maximum variable horizontal distance between the first wedge prism 131 and the second wedge prism 132 in a state in which the focus is aligned at the center of the aperture of the scanner 140.

Further, as shown in FIG. 4C, the diameter of the inlet and outlet of the porous pattern of the workpiece 160 or the inclined surface (taper) between the inlet and outlet may be adjusted in the helical optical system 130 by adjusting the relative horizontal distance without changing the angles of the first wedge prism 131 and the second wedge prism 132.

As described above, the helical optical system 130 may space the multiple laser beams apart from the central axis, laterally offset the multiple laser beams, and output the multiple laser beams. Further, the helical optical system 130 may include a first wedge prism 131 and a second wedge prism, and may additionally include a polarizer 133 between the first and second wedge prisms 131 and 132. In some examples, the respective incident surface and the exit surface of the first and second wedge prisms 131 and 132 have different inclinations, so that the laser beams may be moved to a position spaced apart from the central axis. The perforation angle on the focal plane may vary according to the distance between the first and second wedge prisms 131 and 132 (see FIG. 4C). The helical optical system 130 including the first and second wedge prisms 131 and 132 and the polarizer 133 may adjust the distance between the first and second wedge prisms 131 and 132 to create a lateral offset at the inlet of the focusing lens 150. The offset created by the first and second wedge prisms 131 and 132 may change the angle between the processing plane (focal plane) and the laser beam. If set to an appropriate angle, drilling may be performed by rotating the laser beam by the oscillation of the scanner 140 mirror. As described above, the polarizer 133 may be inserted between the first and second wedge prisms 131 and 132 to reduce the occurrence of a longitudinal/transverse offset due to polarization.

As described above, the helical optical system 130 adjusts the distance between the first and second wedge prisms 131 and 132 to create a lateral offset at the inlet of the focus lens 150. Only the relative distance between the first and second wedge prisms 131 and 132 may be changed without changing the angle. In some examples, while the first wedge prism 131 is fixed, the second wedge prism 132 moves transversely along the main propagation axis, adjusting the distance. Of course, the incident angle and the focusing position may be varied by rotating the second wedge prism 132. However, in the present invention, the second wedge prism 132 may be controlled to move only in the transverse direction so that only the distance from the first wedge prisms 131 is adjusted without rotating in place. If the second wedge prism 132 moves in the transverse direction, the point where the laser is focused is the same, but the incident angle of the laser may be adjusted.

In some examples, the offset created by the first and second wedge prisms 131 and 132 changes the angle between the processing plane (focal plane) and the laser beam. If set to an appropriate angle, drilling may be performed by rotating the laser beam by the oscillation of the scanner 140 mirror.

In the helical optical system 130 used in the system 100 of the present invention, it is important to make an ideal parallel beam incident for a correct phase change of the helical optical system 130. Therefore, at the front of the diffractive optical system 120, the beam expander 121 expands the laser beam and introduces a laser beam of uniform intensity into the input unit of the diffractive optical system 120. Further, the lens 123 at the rear of the diffractive optical system 120 transforms the beams split by diffraction into parallel beams. Finally, the beam blocking mask 124 may be used to block the high-order sub laser beams which are unnecessarily generated by the diffractive optical system 120, preventing processing at an unnecessary position.

The system 100 of the present invention may adjust the displacement of the laser beam by moving the first and second wedge prisms 131 and 132 along the optical axis of the helical optical system 130 or rotating the first and second wedge prisms 131 and 132 around the optical axis of the helical optical system 130. The position where the laser beam is incident on the objective focus lens 150 varies according to the displacement, and in this case, the incident angle of the laser beams collected at the same position, formed on the processing surface, may also vary by the nature of the F-theta lens.

However, as the Galvano mirror scanner has a predetermined aperture pupil, the range of position adjustment of the laser beam by the first and second wedge prisms 131 and 132 may be limited. If the laser beam is not incident on the pupil of the scanner 140 due to excessive refraction due to the position movement or rotation of the first and second wedge prisms 131 and 132, the output of the laser beam may decrease. When the angle between the two surfaces of the first and second wedge prisms 131 and 132 is a, and the refractive index of the prism is n, the refractive angle is equal to (n−1)a.

In the present invention, the helical optical system 130 may adjust the angle of the laser beam incident on the processing plane. The angle adjustment unit has, at least, first and second wedge prisms 131 and 132 and a polarizer 133, and each unit may be disposed in line with each other along the optical axis.

The first and second wedge prisms 131 and 132 may change the propagation direction by refracting light according to the inclination angle and thickness change of the prism. In other words, it has a cylindrical structure, and one end of the component may be the thickest and the other end may be the thinnest.

The first wedge prism 131 may have an incident surface inclined in a direction crossing the central axis and an exit surface horizontally formed on the opposite side to the incident surface. The laser beam exiting the exit surface is emitted by being bent toward the thick side of the first wedge prism 131, and may be inclined with respect to the central axis.

The polarizer 133 is a λ/4 (half wave plate) and may be positioned between the first wedge prism 131 and the second wedge prism 132.

The second wedge prism 132 is disposed at the front end of the Galvano mirror scanner, and may have an incident surface horizontally formed in a direction crossing the central axis, and an exit surface inclined on the opposite side to the incident surface. The laser beam may be incident on the second wedge prism 132 according to the angle generated by the first wedge prism 131. The laser beam may be bent toward the thick side of the prism, and be changed in a direction parallel to the initial main light axis.

However, the inclination angles of the first wedge prism 131 and the second wedge prism 132 should be the same and may be required to be disposed to be engaged with each other. In other words, the thinnest side of the second wedge prism 132 may be required to be positioned on the thickest side of the first wedge prism 131.

As such, the second wedge prism 132 or the first wedge prism 131 may be configured to be mounted on a transfer device to perform linear reciprocating motion in the horizontal direction. The transfer distance may be configured to have a resolution in a range of about 1 μm to 90 μm in order to obtain a phase shift amount of up to 2 pi required by the phase shift method.

As described above, the helical optical system 130 composed of the first and second wedge prisms 131 and 132 may basically adjust the refraction and displacement by changing the distance and angle between the prisms. However, in the present invention, only translational movement, rather than rotational motion, of the first and second wedge prisms 131, 132 is adopted as the operating principle. In other words, the system 100 according to the present invention uses a galvo scanner for arrangement movement of a multi-beam array, and the laser beams should be incident straight or in parallel on the scanner aperture. If the first and second wedge prisms 131 and 132 are rotated, refraction occurs so that the laser beams are not parallel to the main light beam, and may not be incident in parallel on the scanner 140. Therefore, the first and second wedge prisms 131 and 132 may be limited to left and right movement for displacement, and the rotation of the beam spot required for drilling may have to be performed by the galvo mirror of the scanner 140. Of course, it may vary according to the type and arrangement of the wedge prisms.

Referring again to FIG. 4C, a drilling taper adjustment method by the system 100 of the present invention (a hole diameter adjustment method by the helical optical system 130) is described. In a typical optical system (see a), a positive taper inclined surface is formed. On the other hand, the system 100 to which the helical optical system 130 is applied may change the diameter and ratio of the upper end (entrance) and the lower end (exit) by adjusting the perforation inclined surface (taper) (b: small incident angle, c: large incident angle). The first and second wedge prisms 131 and 132 change only the relative distance without changing the angle. In other words, while the first wedge prism 131 is fixed, the second wedge prism 132 moves in the transverse direction along the main propagation axis so that the distance may be adjusted. Of course, the incident angle may be adjusted by rotating the second wedge prism 132, but in the present invention, the second wedge frame is controlled to move in the transverse direction without rotating in place. However, excessive expansion of the prism spacing may cause energy loss due to beam clipping as the laser beam moves out of the aperture of the scanner 140. Therefore, in order to prevent a significant laser output drop and beam quality deterioration, the maximum variable distance should be found after focusing the lens at the center of the aperture.

A porous pattern, i.e., a through hole may be formed by the following steps.
Step 1. The beam array is disposed at the center of the target position using the scanner 140.
Step 2. The motor of the helical optical system 130 is controlled to move the distance between the first and second wedge prisms 131 and 132.
Step 3. A side offset occurs and the incident angle of the laser beam is changed.
Step 4. The first and second mirrors 141 and 142 of the scanner 140 are rapidly moved (wobbled) to rotate the tilted beam at the original position.
Step 5. A through hole (through via hole) is generated in a plane by all beam matrix arrays generated by the diffractive optical system 120.

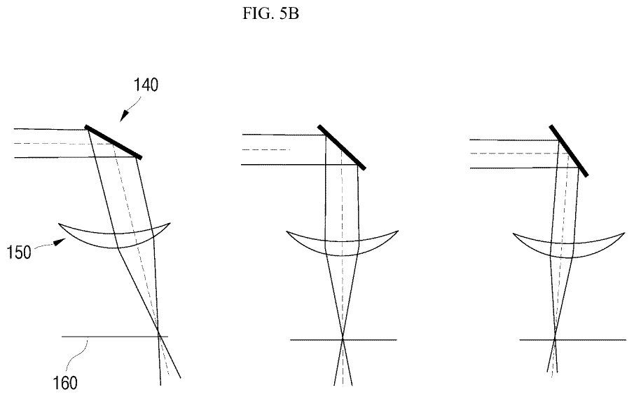

FIGS. 5A and 5B are views schematically illustrating a configuration and operation of the scanner 140 of the laser drilling system 100 according to the present invention.

As illustrated in FIGS. 5A and 5B, the laser processing scanner 140 may include a first reflection mirror 141, a first galvo motor driving the first reflection mirror 141, a second reflection mirror 142, and a second galvo motor driving the second reflection mirror 142. In other words, the two motors may be disposed apart from each other and reflection mirrors may be respectively attached thereto, controlling the position in the two-dimensional area. For example, the scanner 140 according to the present invention includes a two-axis Galvano mirror scanner, and each of the multiple laser beams may be spirally moved by the two-axis Galvano mirror scanner to perforate a porous pattern in the workpiece 160, and all of the multiple laser beams focused on the workpiece 160 may be moved in parallel.

The laser beams whose optical axis position is adjusted by the helical optical system 130 may enter the scanner 140. The scanner 140 has first and second mirrors 141 and 142, and may control the position and the propagation path of the laser beams using the first and second mirrors 141 and 142. The scanner 140 may include a controller for controlling the rotation of the galvo motor. The diffractive optical system 120 may form an N×N matrix in which N sub beams are arranged. When the workpiece 160 exceeds the matrix area or the size of the pattern is small for precise processing, the position of the matrix may be moved to the scanner 140. The rectangular matrix may effectively minimize the overlapping or missing portions between the matrices.

The galvo scanner rotates finely to spirally move the laser beams finely on the workpiece 160 by fine rotational vibration, and may drill the workpiece 160 by the vibration. Further, the galvo scanner may move all the multiple beams focused on the workpiece 160 in parallel by adjusting and rotating the two motors. If processing for one array or matrix is finished, all the multiple beams may be moved to the next array or matrix.

Meanwhile, the scanner 140 may process the hole by controlling the angle of the laser beams incident on the focus lens 150 (i.e., an F-theta lens) and radiating the laser beams to a predetermined position of the workpiece 160. As described above, the scanner 140 may include a controller for controlling the rotation of the galvo motor. However, the present invention may increase production yield by minimizing fine movement of the scanner 140 and mitigating workability deterioration due to movement between scan areas by forming a pattern with a multi-beam array generated by the diffractive optical system 120.

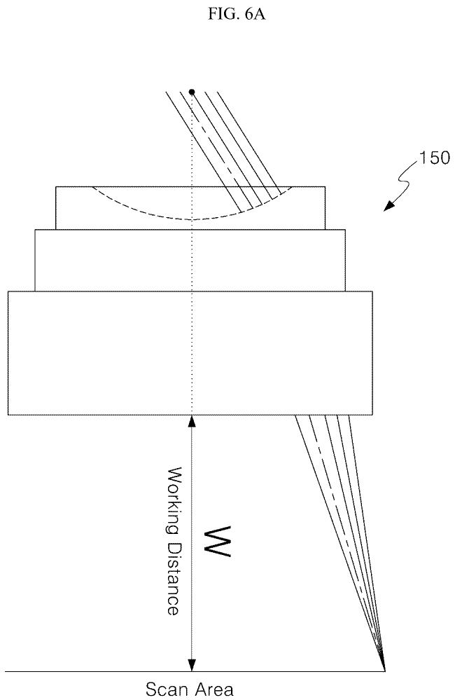

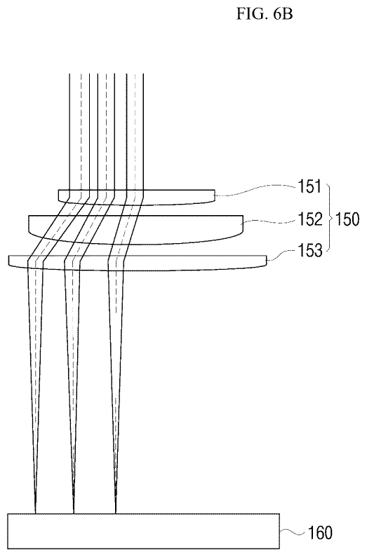

FIGS. 6A and 6B are views schematically illustrating a configuration and operation of the focus lens 150 of the laser drilling system 100 according to the present invention.

As illustrated in FIGS. 6A and 6B, the focus lens 150 may include or be referred to as an F-theta lens, and the multiple laser beams with the same incident angle may be focused at the same position of the workpiece 160. In some embodiments, the focus lens 150 may include at least one of F-theta lenses including three individual lenses: a first individual lens 151 as a concave-concave lens having a focal length f1, a second individual lens 152 as a concave-convex lens having a focal length f2, and a third individual lens 153 as a biconvex lens having a focal length f3. The F-theta lens has a total focal length f, and each product may have a predetermined ratio between the total focal length f and the focal lengths f1-f3.

The focus lens 150 may perforate the porous pattern by radiating the multiple laser beams output from the scanner 140 to the focal plane of the workpiece 160. If the galvo motor of the scanner 140 rotates according to a position value set in the coordinate system, the multiple laser beams may be introduced into the focus lens 150 while being reflected by the first and second mirrors 141 and 142. The position on the focal plane may be determined by an angle, rather than the position where the laser beam is focused in the input unit of the focus lens 150.

The laser beams may be guided to the scanner 140, the focus lens 150 including an F-theta lens is disposed under the scanner 140, and a wavelength plate may be further disposed between the F-theta lens and the workpiece 160. While the laser beams scanned from the scanner 140 pass through the F-theta lens, the light receiving deviation or the like may be corrected. As described above, the F-theta lens is composed of a plurality of lenses 151, 152, and 153, and an anti-reflection film may be coated on two opposite surfaces of each lens.

To maintain a constant distribution and pitch of the laser beams even when the incident angle formed by the rotation of the first and second mirrors 141 and 142 of the scanner 140 changes, the incident angle Theta and the moving position of the laser beams from the center position of the plane may have to be proportional. In other words, a lens in which the beam is positioned at the same point as the product (F×Theta) of the incident angle theta and the focal length f for the lens is required, which is called an F-theta lens. It is different from a general lens and may have a special shape and an overlapping structure. The F-theta lens focuses at the same position on the focal plane if the incident angles are the same.

The beam array whose angle is adjusted by the helical optical system 130 and the scanner 140 may be condensed on the upper surface of the workpiece 160 by the F-theta lens. Each beam split by the diffractive optical system 120 is incident at each position of the workpiece 160, the array interval is determined by the diffractive optical system 120, and the angle may be determined by the helical optical system 130 and the scanner 140. In general, the focal position is the same, but the incident angle may vary due to the displacement of the laser beam by the helical optical system 130. The incident angle formed with respect to the processing surface may increase toward the center of the lens, and the incident angle may decrease toward the periphery.

In order to enhance work flexibility, the system 100 according to the present invention may use a Galvano mirror scanner as described above. The laser beams are moved to a desired position of the workpiece 160 in two orthogonal directions, X-axis and Y-axis. If the incident angle is determined by the helical optical system 130, the first mirror 141 and the second mirror 142 of the scanner 140 may conically rotate the beams to perform drilling.

Meanwhile, the focal position of the F-theta lens may be determined in proportion to the angle (theta) of incidence on the lens (f*theta). However, even at the same incident angle (theta), if there is a displacement, the imaging angle of the transmitted light may vary. For example, even with the same vertically incident light, the imaging angle when it passes through the center of the lens becomes 90°, and the imaging angle may decrease as the distance from the center increases. The present invention may mitigate the inclined surface (taper) that occurs during drilling by varying the imaging angle by adjusting the displacement of the incident laser beam using the first and second wedge prisms 131 and 132.

In order to enhance work flexibility, the system 100 according to the present invention uses a Galvano mirror scanner, and moves the laser beam to a desired position on the workpiece 160 in directions orthogonal to each other, and then, if the incident angle is determined by the helical optical system 130, the first mirror 141 and the second mirror 142 of the scanner 140 may conically rotate the beam to perform drilling.

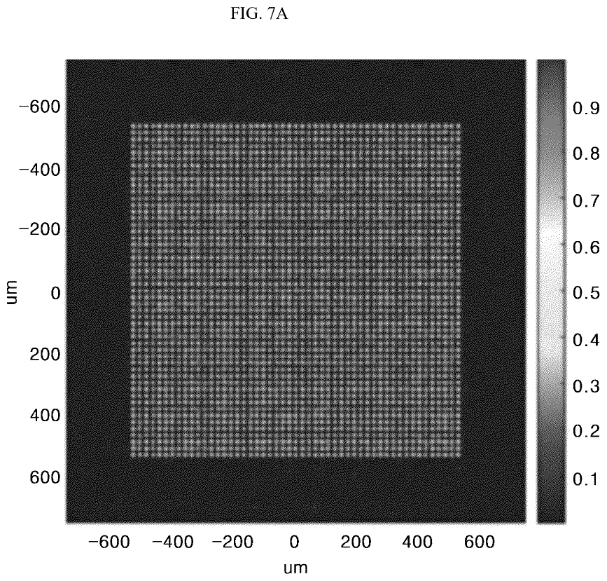

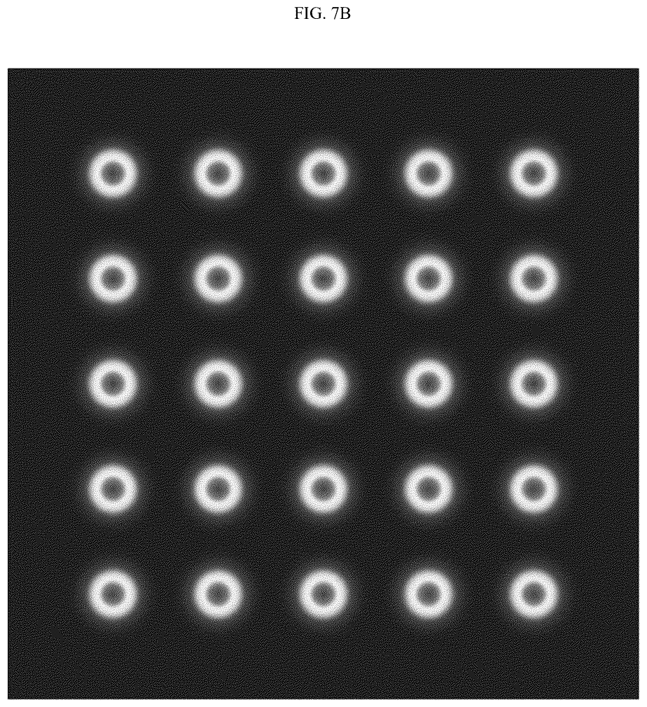

FIGS. 7A and 7B are views schematically illustrating a simultaneous operation of laser beams by the laser drilling system 100 according to the present invention.

As illustrated in FIGS. 7A and 7B, multiple spots arranged in a matrix form may be made with the introduced laser beams. Therefore, according to the system 100 of the present invention, simultaneous processing of a large area is possible without moving the galvo scanner or the stage. Further, the arrangement to be formed may be configured in various shapes and arrangements such as Gaussian, flat top (circular, rectangular, square), line spots, etc., according to the design of the diffraction grating.

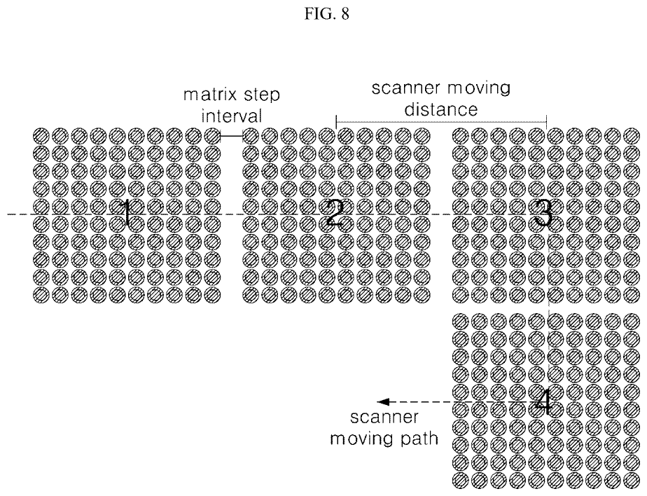

FIG. 8 is a view schematically illustrating a pattern movement operation by the laser drilling system 100 according to the present invention.

As illustrated in FIG. 8, the diffractive optical system 120 may form an N×N matrix in which N sub beams are arranged. When the workpiece 160 exceeds the matrix area or the size of the pattern is small for precise processing, the position of the matrix may be moved to the scanner 140. The rectangular matrix may effectively minimize the overlapping or missing portions between the matrices.

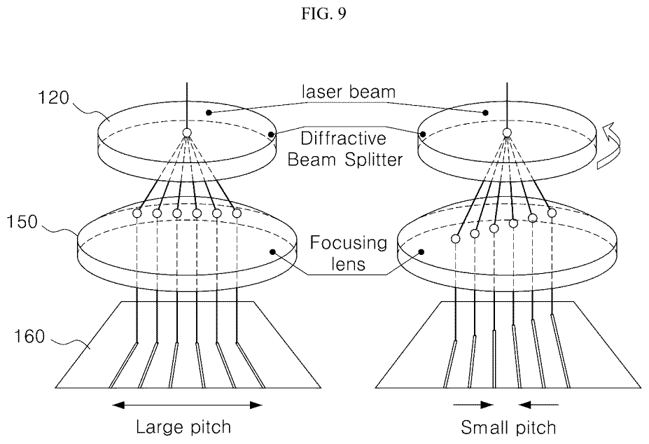

FIG. 9 is a view schematically illustrating a pattern change operation by a laser drilling system 100 according to the present invention.

As illustrated in FIG. 9, the diffractive optical system 120 is rotated to adjust the pitch of the multiple laser beams, so that the pattern may be changed. In other words, the pitch of the multiple laser beams may be widened or narrowed according to the rotation of the diffractive optical system 120.

As such, the processing method using the pulse train of the scanner 140 according to the present invention may increase productivity by increasing the processing speed of the laser. However, it is difficult to process components without lowering the average power of the laser source 110. The reason is that thermal effect applied to the component may lead to deformation (or even destruction), oxidation, or structural change.

This thermal effect is more dangerous when areas very close to each other on the same material should be quickly processed. In fact, processing a point in the local area heats the adjacent area, resulting in deformation in the overall quality. The heat generated during processing of the adjacent area is difficult to remove during processing of a new area, which requires a delay in production time. The proposed invention may reduce the shape change of the processing portion due to thermal distribution of the peripheral portion by simultaneous processing of the pattern by the diffractive optical system 120.

Furthermore, the method of deflecting a laser beam using the scanner 140 is the most commonly employed method because it is easy to use and allows for a fast processing speed. However, because the laser beams generally have a Gaussian distribution, the use of scanner 140 creates a conical cutting surface. Such a cutting surface is inevitably difficult to be perpendicular to the processing surface, resulting in fatal quality defects in fine patterning applications. In order to suppress the conicity of the cutting surface, a precession device capable of controlling the processing angle of the laser beam has been developed. However, as only one processing point may be processed per cycle, there is a disadvantage of work delay. The present invention may increase the number of holes processed per cycle by combining a diffractive optical system 120, a scanner 140, and a helical optical system 130.

Although, in the present invention, a method for forming a porous pattern in a metal support for a solid oxide fuel cell as a workpiece 160 has been described, the invention may also be utilized in the following areas.

For example, the system 100 according to the present invention is applicable to the field of printed circuit boards. In a printed circuit board, one side is used for relatively simple electronic devices. However, recently, double-sided substrates, in which circuits are formed on both sides and interconnected through through holes, or multilayer substrates, which expand not only to both sides but also to multiple layers, are increasingly being used. Therefore, the system 100 according to the present invention may be applied. Further, the system 100 according to the present invention may be applicable to the fields of display, semiconductor, or semiconductor packaging. For example, processing of glass via holes, silicon via holes, or mold via holes is required in these fields. The laser beam of the ultraviolet laser may be directed toward the substrate at a predetermined location with the pulse of the laser, and the laser beam may be repeatedly pulsed to form a through hole. If chemical etching is simultaneously performed in the deformed area generated on the surface, a through hole with minimized fine cracks may be obtained.

The description above is merely an exemplary embodiment of a porous pattern perforation system using an exemplary multiple laser beams according to the present invention. The present invention is not limited to the aforementioned embodiment but may be subject to various modifications within the scope of the invention without departing from the gist of the invention as claimed in the following claims. Such modifications may be made by any person skilled in the art to which the invention pertains, thereby encompassing the technical spirit of the present invention to the extent of the possible variations.

What is claimed is:

1. A laser drilling system comprising:
a laser source outputting a single laser beam;
a diffractive optical system converting the single laser beam into multiple laser beams and outputting the multiple laser beams;
a helical optical system spacing the multiple laser beams apart from a central axis, laterally offsetting the multiple laser beams, and outputting the multiple laser beams;
a scanner changing a position and propagation path of the multiple laser beams laterally offset from the central axis and outputting the multiple laser beams; and
a focus lens radiating the multiple laser beams output from the scanner onto a focal plane of a workpiece to drill a porous pattern.

2. The laser drilling system of claim 1, wherein the diffractive optical system includes:
a beam expander uniformly expanding the single laser beam;
a diffractive optical element splitting the expanded single laser beam into the multiple laser beams; and
a lens transforming the split multiple laser beams into parallel beams.

3. The laser drilling system of claim 2, wherein the diffractive optical system further includes a beam blocking mask blocking the multiple laser beams of a high order.

4. The laser drilling system of claim 1, wherein the helical optical system includes:
a first wedge prism having an incident surface and an exit surface at different angles to space the multiple laser beams apart from the central axis; and
a second wedge prism having an incident surface and an exit surface at different angles and, as a horizontal distance from the first wedge prism is adjusted, laterally offsetting and outputting the multiple laser beams.

5. The laser drilling system of claim 4, wherein the helical optical system further includes a polarizer disposed between the first wedge prism and the second wedge prism to reduce a transverse and longitudinal offset caused by polarization.

6. The laser drilling system of claim 4, wherein the helical optical system adjusts diameters of an inlet and an outlet of the porous pattern of the workpiece, and an inclined surface between the inlet and the outlet by changing a relative horizontal distance between the first wedge prism and the second wedge prism without changing angles of the first wedge prism and the second wedge prism.

7. The laser drilling system of claim 4, wherein the helical optical system sets a maximum variable horizontal distance between the first wedge prism and the second wedge prism in a state where a focal point is aligned at a center of an aperture of the scanner.

8. The laser drilling system of claim 1, wherein the scanner includes a two-axis Galvano mirror scanner, wherein the two-axis Galvano mirror scanner causes each of the multiple laser beams to perform helical motion to drill the porous pattern into the workpiece, and translate in parallel all of the multiple laser beams incident on the workpiece.

9. The laser drilling system of claim 1, wherein the focus lens includes an F-theta lens, and wherein each of the multiple laser beams having the same angle of incidence is focused on the same location of the workpiece by the F-theta lens.

10. The laser drilling system of claim 1, wherein the diffractive optical system is rotated to adjust a pitch of the multiple laser beams.
